(19) United States
(12) Patent Application Publication
(10) Pub. No.: US 2011/0301970 A1
(43) Pub. Date: Dec. 8, 2011

(54) METHOD FOR SUPPORTING SERVICE BASED ON INFORMATION TERMINAL AND SYSTEM FOR SUPPORTING SERVICE USING THE METHOD

(75) Inventors: Chang Seok BAE, Daejeon (KR); Jeun Woo Lee, Daejeon (KR); Hyung Jik Lee, Daejeon (KR)

(73) Assignee: ELECTRONICS AND TELECOMMUNICATIONS RESEARCH INSTITUTE, Daejeon (KR)

(21) Appl. No.: 13/151,677

(22) Filed: Jun. 2, 2011

(30) Foreign Application Priority Data
Jun. 3, 2010 (KR) 10-2010-0052391

(51) Int. Cl. G06F 15/16; G06Q 50/00

(52) U.S. Cl. 705/2; 709/219

(57) ABSTRACT

In the present invention, an information terminal with a high-performance graphic and a processor accesses the server providing a predetermined service of a predetermined institution through a wired/wireless communication network to provide a service to virtually experience the predetermined service in advance in the virtual reality and additional information associated with the predetermined service is provided through the augmented reality in real time to allow the user to conveniently use a predetermined complicated service provided from the predetermined institution.

### CROSS-REFERENCE TO RELATED APPLICATIONS

This application claims priority under 35 U.S.C. §119 to Korean Patent Application No. 10-2010-0052391, filed on Jun. 3, 2010, in the Korean Intellectual Property Office, the disclosure of which is incorporated herein by reference in its entirety.

### TECHNICAL FIELD

The present invention relates to a method for supporting a service based on an information terminal and a system for supporting a service using the method, and more particularly, to a method for supporting a service based on an information terminal and a system for supporting a service using the method that provide virtual experience using virtual reality and augmented reality and support the use of a realistic service.

### BACKGROUND

Even general persons as well as disabled persons and old persons undergo a lot of time and difficulties in using complex services such as a medical service in a general hospital. In particular, a user who firstly uses medial institutions undergoes more difficulties in using the complex services.

With the development and generalization of the Internet, most medical institutions and institutions providing other services provide a lot of information required to use services through homepages. However, the information is provided in a fragmentarily arranged pattern and difficult for the user to intuitively understand.

Various medical institutions computerize the whole course of medical treatment reservations, receptions, various examinations, treatments, medical prescriptions, and payment of medical fee, and manage information on patients by generating a database associated with information on patients.

This access just provides business convenience of persons who engage in hospitals but do not directly help the patients to conveniently use services. That is, an environment, which provides intelligent and efficient services such as finding in advance that patients arrive at the medical institution and automatically performing receptions, preparing for an existing medical treatment record, and preparing various examinations and treatments in order beforehand, cannot be prepared.

### SUMMARY

An exemplary embodiment of the present invention provides a method for supporting a service based on an information terminal, including: executing, by an information terminal of a user, a virtual experience service application program stored therein in order for the user to virtually experience in advance a predetermined service received by actually visiting a predetermined institution; accessing, by the information terminal, a server providing a virtual experience service through a router in accordance with the virtual experience service application program; requesting, by the information terminal, the virtual experience service for the predetermined institution to the server; and constructing, by the server, a virtual reality space corresponding to the predetermined institution in accordance with the request for the virtual experience service and associating service elements associated with the predetermined service with the constructed virtual reality space to transmit the service elements to the information terminal.

Another exemplary embodiment of the present invention provides a method for supporting a service based on an information terminal, including: accessing, by the information terminal of a user, a server through a wireless access point device installed in a predetermined institution; executing, by the information terminal, a virtual experience service application program installed therein; transmitting, by the information terminal, present positional information indicating a present location of the user to the server through the wireless access point device in real time when the user moves in the predetermined institution; constructing, by the server, an augmented reality space corresponding to the present location by receiving the present positional information and associating the constructed augmented reality space with a service element corresponding to a predetermined service provided at the present location to transmit the service element to the information terminal; and receiving, by the information terminal, the augmented reality space associated with the service element and providing the predetermined service provided at the present location in the augmented reality space through the virtual experience service application program.

Yet another exemplary embodiment of the present invention provides a system for supporting a service based on an information terminal, including: an application server accessing the information terminal through a router, constructing a virtual reality space and an augmented reality space associated with a service element corresponding to a predetermined service provided by a predetermined institution, and transmitting the constructed virtual reality space and augmented reality space to the information terminal through the router; a service element server being associated with the application server and providing the service element to the application server in accordance with a request from the application server; and a virtual reality/augmented reality server being associated with the application server and providing the virtual reality space and the augmented reality space to the application server in accordance with the request from the application server.

Other features and aspects will be apparent from the following detailed description, the drawings, and the claims.

### BRIEF DESCRIPTION OF THE DRAWINGS

FIG. 1 is a configuration diagram of a medical service virtual experience and supporting service system based on a fixed information terminal such as an IPTV or a game console and a portable information terminal such a smart phone or a portable game machine according to an exemplary embodiment of the present invention.

FIG. 2 is an operational flowchart showing a medical service virtual experience remotely based on a portable information terminal and a fixed information terminal according to an exemplary embodiment of the present invention.

FIG. 3 is an operational flowchart for supporting a medical service remotely based on a portable information terminal according to an exemplary embodiment of the present invention.

FIGS. 4 to 6 are configuration diagrams of an application server, a virtual reality and augmented reality server, and a service element server according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

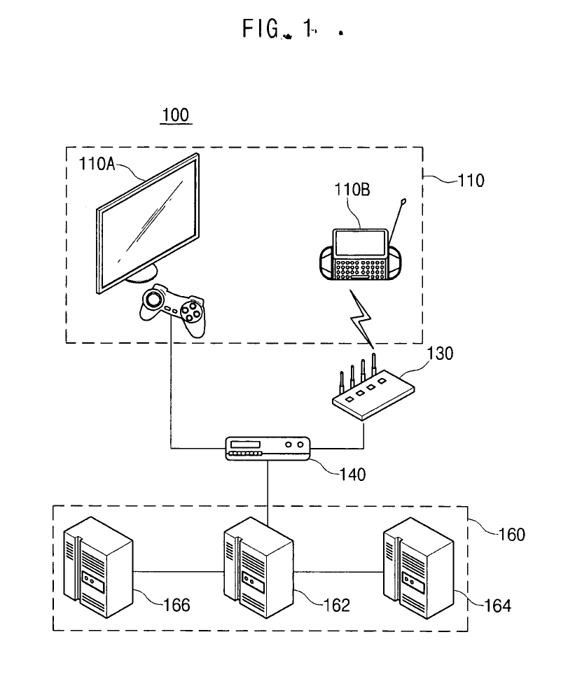

FIG. 1 is an overall configuration diagram of a medical service supporting system based on an information terminal according to an exemplary embodiment of the present invention.

Referring to FIG. 1, an information terminal based service supporting system 100 according to an exemplary embodiment of the present invention provides a service that allows a predetermined service provided by a predetermined institution to be experienced in a virtual realistic space in advance or additional information associated with the predetermined service and reality to be experienced in an augmented realistic space. Herein, an augmented reality (AR) is the technology that shows a state in which a virtual object is overlapped with a real world which a user sees through his/her eyes. Since the augmented reality mixes a virtual world having additional information with the real world in real time and shows the mixed virtual world and real world as one image, the augmented reality is also called a mixed reality (MR). A virtual reality technology cannot see a real environment by providing only a virtual environment, but the augmented reality technology provides the real environment by mixing a virtual object with the real environment. As a result, better reality and additional information are provided.

In the exemplary embodiment, a medical institution as the predetermined institution will be described as an example. Therefore, in the specification, the information terminal based service supporting system is written as an information terminal based medical service supporting system. Of course, the predetermined institution is not limited to a medical institution and may include various public institutions and private institutions. That is, the information terminal based service supporting system according to the exemplary embodiment of the present invention may allow the user to experience in advance predetermined services provided from the various institutions or provide realistic additional information to the user, in the virtual realistic space or the augmented realistic space.

The information terminal based medical service supporting system 100 according to the exemplary embodiment of the present invention includes an information terminal 110, a wireless access point device 130, a router 140, and a server 160.

The information terminal 110 includes a fixed information terminal 110A and a portable information terminal 110B. The fixed information terminal 110A incorporates a local area network (LAN) device, is connected to the router 140 through the LAN device, and may access the Internet through the router 140. Examples of the fixed information terminal 110A may include an IPTV, a game console, and the like. The portable information terminal 110B is connected to the wireless access point device 130 installed in the vicinity thereof by using the wireless LAN device incorporated therein. The portable information terminal 110B is connected to the router 140 by using the wireless access point device. The portable information terminal 110B may access the Internet through the wireless access point device 130 and the router 140 and examples of the portable information terminal 110B may include a smart phone, a portable game machine, and the like.

The router 140 connects the fixed information terminal 110A and the portable information terminal 1110B to the Internet through the Internet and ultimately connects both terminals to the server 160.

The server 160 includes an application server 162, a service element server 164, and a virtual reality (VR)/augmented reality (AR) server 166.

The application server 162 transmits service applications associated with the medical service to the information terminal 110 through the Internet. Therefore, the information terminal 110 including 110A and 110B receives a predetermined service of a user's desired medical institution, i.e., the medical service.

The information terminal 110 including 110A and 110B executes a virtual experience service application program provided by the application server 162 and selects a medical institution from which the user intends to experience the service through the executed virtual experience service application program.

The application server 162 retrieves the medical service provided by the medical institution selected by the user in association with the service element server 164 and receives a service element corresponding to the medical service provided by the selected medical institution. Further, the application server 162 receives virtual reality information and/or augmented reality information required for the user to experience the medical service of the medical institution in association with the virtual reality/augmented reality server 166.

Thereafter, the application server 162 constructs the virtual reality space and/or the augmented reality space based on the received virtual reality information and/or augmented reality information and associates the service element received in the service element server with the virtual reality space and/or augmented reality space.

The application server 162 transmits the service element associated with the virtual reality space and/or augmented reality space to the information terminal 100 through the router 140 and the wireless access point device 130. As a result, the user experiences in advance the medical service in the virtual reality space through his/her own information terminal 110 or receives various additional information associated with the realistic medical service in the augmented reality space.

As described above, the information terminal based medical service supporting system 100 according to the exemplary embodiment of the present invention provides a virtual medical experience service for the user to virtually experience the medical service in advance, remotely through the information terminal 110. Further, the information terminal based medical service supporting system 100 provides a site support service of the medical service for the user to receive a required service even at the time of arriving at a hospital, by using the augmented reality. The site support service of the medical service, i.e., the medical service which the user receives at the time of arriving at the hospital may be received from the portable information terminal 110B which is relatively convenient to carry, such as the smart phone or the portable game machine. For example, when the user arrives at the hospital, the user's own portable information terminal 110B accesses the Internet through the wireless access point device 130 installed at an entrance of the hospital and accesses the application server 162 through the accessed Internet. The application server 162 receives terminal information including user information from the accessed portable information terminal 110B to perform authentication. When the authentication is succeeded, the application server 162 recognizes that the user arrived at the hospital. That is, the application server 162 recognizes that the user's own portable information terminal is positioned at the entrance of the hospital. Therefore, the application server 162 prepares for a medical service which should be provided to the recognized portable information terminal 110B and provides the prepared medical service to the portable information terminal 110B. Further, this system 100 recognizes in real time a status in which the user moves in the hospital and when an event to reach a predetermined location in the general hospital occurs, the system 100 provides a prepared medical service corresponding to the event. For example, when the user comes close to a reception desk, a system installed at the reception desk recognizes the user who comes close and automatically prepares for reception information regarding the user in advance. Further, the medical service supporting system provides various medical service guides and using methods required at a present location of the user through the augmented reality space displayed in the user's portable information terminal.

As described above, in the exemplary embodiment of the present invention, the virtual medical experience service is provided in order for the user to easily use the medical service in the general hospital, but the present invention is not limited thereto and it will be apparent to those skilled in the art that the user can experience various predetermined services through virtual experiences. In this case, a database storing other types of service information in addition to various service information associated with the medical treatment is constructed in the application server 162, the service element server 164, and the virtual reality/augmented reality server 166 of FIG. 1, which allows the user to experience the corresponding service by providing the other types of service information to the information terminal 110.

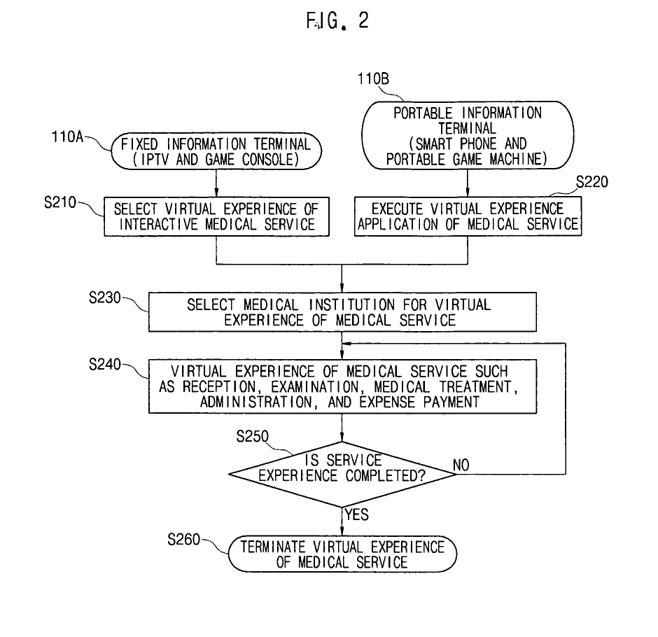

FIG. 2 is a flowchart showing a method for a user to receive a virtual medical service remotely by using the information terminal based medical service supporting system shown in FIG. 1.

Referring to FIG. 2, the user's information terminal 110 of FIG. 1 executes a virtual experience service application program stored therein in order for the user to virtually experience in advance or experience in augmented reality space a predetermined service received by actually visiting a predetermined institution.

When the user uses a fixed information terminal 110A such as an IPTV or a game console, the user selects a virtual experience service of an interactive medical service provided by the remote medical institution through various interfaces provided from the virtual experience service application program executed by the fixed information terminal 110A (S210).

When the user uses a portable information terminal 110B such as a smart phone or a portable game machine, like the user using the fixed information terminal 110A, the user selects and executes the virtual experience application service of the medical service through various interfaces provided from the virtual experience service application program executed by the portable information terminal 110B (S220).

Through the processes (steps S210 and S220), the information terminal requests a virtual experience service for a medical institution to a server.

Subsequently, the user's information terminals 110A and 110B select a user's desired medical institution (S230).

When the medical institution is selected, the user performs virtual experience of various medical services such as a reception service, an examination service, a medical treatment service, an administration service, an expense payment service, and the like provided from the corresponding medical institution by using his/her own information terminals 110A and 110B (S240). That is, the server constructs a virtual reality space and/or an augmented reality space corresponding to the medical institution according to the request for the virtual experience service from the information terminal, and associates service elements related with various medical services with the constructed virtual reality space and augmented reality space to transmit the service elements to the information terminal.

The process (step S240) will be described below in detail. When the information terminal requests the virtual experience service for the medical institution to the server, the information terminal requests information on the medical institution list registered in the server. The server transmits the registered predetermined institution list to the information terminal in response to the request for the information on the medical institution list. The information terminal selects a predetermined institution which the user intends to experience from the received medical institution list and requests the virtual experience service corresponding to the medical institution selected by the information terminal to the server.

Thereafter, the information terminal requests the service element list provided from the selected medical institution and the server transmits the service element list to the information terminal in response to the request for the service element list. The information terminal selects one service element from the received service element list and requests the virtual experience service corresponding to the selected service element to the server.

Thereafter, the server inquires into a service element database provided therein to retrieve the service element selected by the information terminal. At the same time, the server inquires into a virtual reality database provided therein to retrieve virtual reality information of the medical institution selected by the information terminal. The server constructs the virtual reality space based on the retrieved virtual reality information, associates the retrieved service element with the constructed virtual reality space, and transmits the service element associated with the virtual reality space to the information terminal.

The virtual experience of the medical service is continued until the user transmits a termination message to the server 160 of FIG. 1 through his/her information terminals 110A and 110B. When the user terminates the virtual experience of the medical service, all processes of the remote virtual experience service of the medical service are terminated by transmitting a completion message indicating termination to the server 160 of FIG. 1 through his/her own information terminal (S250).

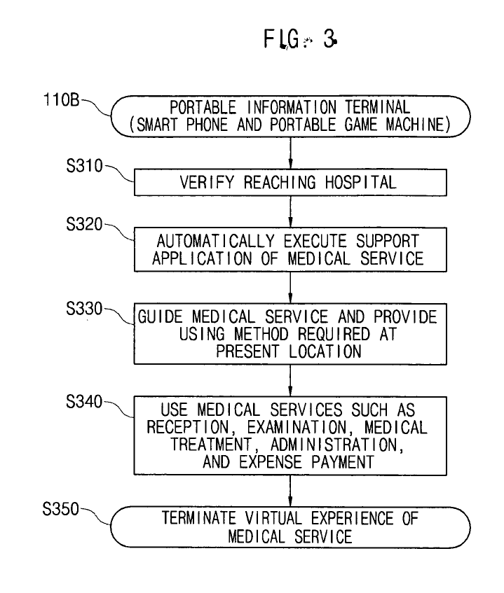

FIG. 3 is a flowchart specifically showing a method for the user to remotely receive the virtual medical service by using the portable information terminal in FIG. 2.

Referring to FIG. 3, when the user having the portable information terminal 110B arrives at the entrance of the medical institution, the user's own portable information terminal 110B transmits the terminal information including the user information to the server through the wireless access point device installed in the vicinity of the entrance of the medical institution. The server performs authentication of the portable information terminal in response to the terminal information and when the authentication is succeeded, the server recognizes that the user having the portable information terminal 110B arrived at the hospital (S310). The server receives positional information (alternatively, movement path information) of the portable information terminal 110B in real time, compares positional information of the hospital with present positional information of the portable information terminal, and verifies whether the user arrived at the hospital according to a comparison result.

Thereafter, in the user's portable information terminal 110B, the virtual experience service application program for supporting the medical service using the augmented reality space is executed (S320). In this case, the server transmits to the portable information terminal 110B the fact that the user having the portable information terminal 110B arrived at the hospital, as a verification message and the portable information terminal 110B may automatically execute the virtual experience service application program in response to the verification message.

Thereafter, as the portable information terminal 110B transmits situational information such as the positional information and the movement path information of the user to the server 160 in real time, the portable information terminal 110B guides a medical service and a using method required at a present location of the user in the hospital (S330). During this process, the user uses various medical services such as reception, examination, medical treatment, administration, expense payment, and the like (S340).

Therefore, when the user goes out of the hospital after receiving all the medical services, the application for supporting the medical service is terminated (S350).

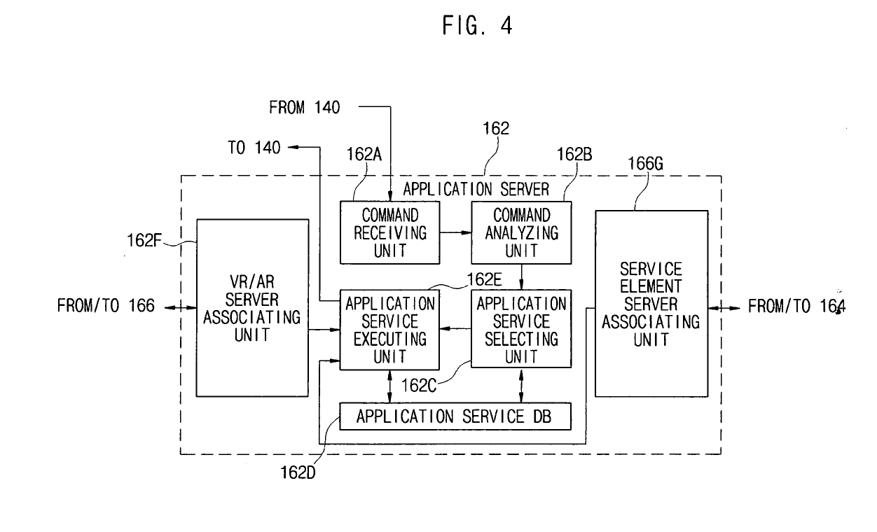

FIG. 4 is a block diagram showing an internal configuration of the application server shown in FIG. 1.

Referring to FIG. 4, the application server 162 includes a command receiving unit 162A, a command analyzing unit 162B, an application service selecting unit 162C, an application service database (DB) 162D, an application service executing unit 162E, a virtual reality/augmented reality server associating unit 162F, and a service element server associating unit 166G.

The command receiving unit 162A receives a user command from the fixed information terminal 110A such as the IPTV or game console and the portable information terminal 110B such as the smart phone or portable game machine through the router 140 of FIG. 1 and transfers the received user command to the command analyzing unit 162B.

The command analyzing unit 162B analyzes and executes the user command received from the command receiving unit 162A.

The application service selecting unit 162C selects a user's desired application service among application services included in an application service database 470 in association with the command analyzing unit.

When the user's desired application service is selected by the application service selecting unit, the application service executing unit 162E executes the selected application service and transmits an executed result to the fixed information terminal 110A or the portable information terminal 110B.

Thereafter, the user virtually experiences the service through his/her own terminal.

While experiencing the service, the service elements that are basic elements constituting the service are received from the service element server 164 through the service element server associating unit 166G. Herein, the service elements are called subservices acquired by subdividing the medical service, such as the reception service, the examination service, the medical treatment service, the administration service, the expense payment service, and the like in the case of the medical service as an example. That is, the application server 162 receives service information associated with the reception service, service information associated with the examination service, service information associated with the medical treatment service, and the like, as the service elements of the medical service, through the service element server associating unit 166G provided therein.

The application server 162 constructs a service space corresponding to each service element, i.e., a virtual space in order to execute the received service elements. The virtual reality information or augmented reality information required to construct the service space is acquired from the VR/AR server 166 through the VR/AR server associating unit 162F.

As described above, the application server 162 constructs the service elements and each service element in the virtual space and transfers the service elements constructed in the virtual space to the information terminals 110A and 110B to allow the user to virtually experience the service through a display screen provided in the information terminal.

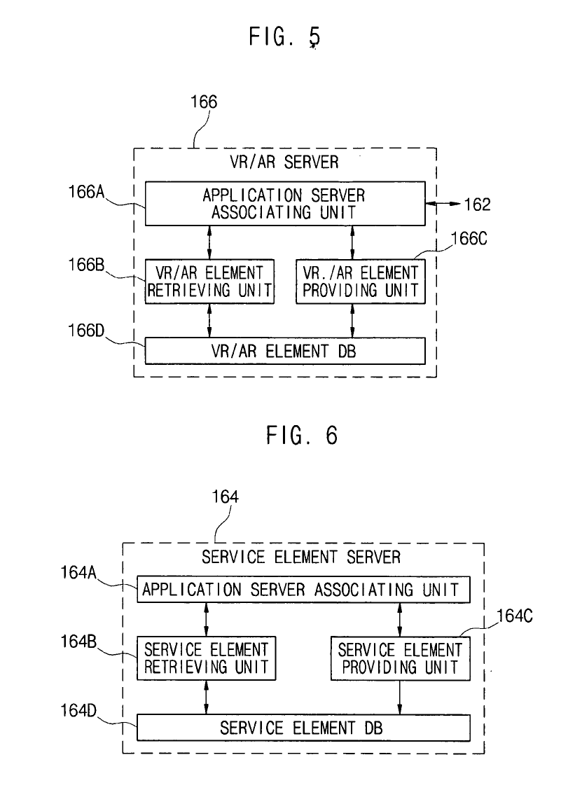

FIG. 5 is a block diagram showing an internal configuration of the VR/AR server associated with the application server shown in FIG. 4.

Referring to FIG. 5, the VR/AR server 166 includes an application server associating unit 166A, an AR/VR element retrieving unit, a VR/AR element providing unit, and a VR/AR element DB.

The application server associating unit 166A transfers a retrieval word for the VR/AR element from the application server 160 to the VR/AR element retrieving unit 166B.

The VR/AR element retrieving unit 166B receives the retrieval word received from the application serve; associating unit 166A and retrieves VR/AR elements required to experience the virtual service corresponding to the received retrieval word by accessing the VR/AR element DB 166D.

The retrieved VR/AR elements are transferred to the application server 162 through the VR/AR element providing unit 166C and the application server associating unit 166A.

FIG. 6 is a block diagram showing an internal configuration of the service element server associated with the application server shown in FIG. 4.

Referring to FIG. 6, the service element server 164 includes an application server associating unit 164A, a service element retrieving unit 164B, a service element providing unit 164C, and a service element DB 164D.

The application server associating unit 164A receives the retrieval world for the service element from the application server 162.

The service element retrieving unit 164B inquires into the service element DB 164D to retrieve the service elements required for the service experience.

The retrieved service elements are transferred to the application server 162 of FIG. 4 through the service element providing unit 164C and the application server associating unit 164A.

As described above, in the exemplary embodiment of the present invention, a user who is not familiar with using a service experiences various services in advance by using virtual reality implemented through various information terminals (the IPTV, the game console, the smart phone, and the portable game machine) to conveniently and easily use a real medical service without difficulty.

Further, according to the exemplary embodiments of the present invention, an operation which uses in order to select and execute service elements while a user experience the service is generated as an event and the user interfaces with a service which the user intends to experience by the event.

During such a service navigation process, a confusion generated at the time of executing the service which the user is not familiar with can be removed through a function to recommend the service.

When the user receives the service in a real service site by using augmented reality based on the portable information terminal such as the smart phone or the portable game machine in addition to virtually experiencing the service remotely, appropriate information required to use of the service can be received through recognition of a situation including the location of the user.

As described above, the servers of FIGS. 4 to 6 may be physically divided and implemented, respectively, but the servers may also be logically divided and implemented in one server.

As described above, the present invention allows the user to virtually experience the predetermined service such as the medical service by using the virtual reality and augmented reality and supports convenient use of the real service. In particular, the present invention allows the user to experience in advance all processes of a complex service by using the virtual reality technology and supports convenient use of the service in using the complex service using user identification, location recognition and situation recognition, and an augmented reality technology in the real service site.

As described above, in the present invention, an information terminal with a high-performance graphic and a processor accesses the server providing a predetermined service of a predetermined institution through a wired/wireless communication network to provide a service to virtually experience the predetermined service in advance in the virtual reality and additional information is provided through the augmented reality in real time to allow the user to conveniently use a predetermined complicated service.

According to exemplary embodiments of the present invention, a user can conveniently and easily use a real service by experiencing various kinds of services in advance and being familiar with the services by using a virtual reality based on various information terminals.

The user receives various services in which the virtual reality and a real reality are mixed with each other by using an augmented reality, such that the user can receive appropriate information required to use the services through recognition of a situation including the position of the user when receiving the services in a real service site.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for supporting a service based on an information terminal, comprising:
executing, by an information terminal of a user, a virtual experience service application program stored therein in order for the user to virtually experience in advance a predetermined service received by actually visiting a predetermined institution;
accessing, by the information terminal, a server providing a virtual experience service through a router in accordance with the virtual experience service application program;
requesting, by the information terminal, the virtual experience service for the predetermined institution to the server; and
constructing, by the server, a virtual reality space corresponding to the predetermined institution in accordance with the request for the virtual experience service and associating service elements associated with the predetermined service with the constructed virtual reality space to transmit the service elements to the information terminal.

2. The method of claim 1, wherein in the executing of the virtual experience service application program, the virtual experience service application program is executed in the information terminal including a desktop computer, an Internet protocol television (IPTV), a game console, a smart phone, and a portable game machine.

3. The method of claim 1, further comprising:
requesting, by the information terminal, the virtual experience service for the predetermined institution to the server;
requesting, by the information terminal, information on the predetermined institution list registered in the server;
transmitting, by the server, the preregistered predetermined institution list to the information terminal in response to the request for the information on the predetermined institution list;
selecting, by the information terminal, a predetermined institution which a user intends to experience from the received predetermined institution list; and
requesting, by the information terminal, the virtual experience service corresponding to the selected predetermined institution to the server.

4. The method of claim 3, further comprising:
requesting, by the information terminal, service elements provided from the selected predetermined institution to the server;
transmitting, by the server, a service element list to the information terminal in response to the request for the service element; and
selecting, by the information terminal, one service element from the received service element list and requesting the virtual experience service corresponding to the selected service element to the server.

5. The method of claim 4, wherein the transmitting of the virtual reality space to the information terminal includes:
inquiring, by the server, into a service element database provided therein and retrieving the service elements selected by the information terminal;
inquiring, by the server, into a virtual reality database provided therein and retrieving virtual reality information of the predetermined institution selected by the information terminal;
constructing, by the server, the virtual reality space based on the retrieved virtual reality information and associating the retrieved service elements with the constructed virtual reality space; and
transmitting the service elements associated with the virtual reality space to the information terminal.

6. The method of claim 5, wherein the predetermined institution is a medical institution.

7. The method of claim 6, wherein the service element provided by the medical institution includes a reception service element, an examination service element, a medical treatment service element, an administration service element, and an expense payment service element.

8. A method for supporting a service based on an information terminal, comprising:
accessing, by the information terminal of a user, a server through a wireless access point device installed in a predetermined institution;
executing, the information terminal, a virtual experience service application program installed therein;
transmitting, by the information terminal, present positional information indicating a present location of the user to the server through the wireless access point device in real time when the user moves in the predetermined institution;
constructing, by the server, an augmented reality space corresponding to the present location by receiving the present positional information and associating the constructed augmented reality space with a service element corresponding to a predetermined service provided at the present location to transmit the service element to the information terminal; and
receiving, by the information terminal, the augmented reality space associated with the service element and providing the predetermined service provided at the present location in the augmented reality space through the virtual experience service application program.

9. The method of claim 8, wherein the accessing of the server includes:
transmitting, by the information terminal, terminal information including user information to the server through the wireless access point device;
authenticating, by the server, the information terminal based on the received terminal information; and
recognizing, by the server, that the user of the information terminal arrives at the predetermined institution when the authentication of the information terminal is succeeded.

10. The method of claim 8, wherein the transmitting of the constructed augmented reality space to the information terminal includes:
retrieving, by the server, the service element corresponding to the present location by inquiring into a service element database provided therein;
retrieving, by the server, augmented reality information corresponding to the present location by inquiring into an augmented reality database provided therein;
constructing, by the server, the augmented reality space based on the retrieved augmented reality information and associating the retrieved service element with the constructed augmented reality space; and
transmitting the service element associated with the augmented reality space to the information terminal.

11. The method of claim 10, wherein the predetermined institution is a medical institution.

12. The method of claim 11, wherein the service element provided by the medical institution includes a reception service element, an examination service element, a medical treatment service element, an administration service element, and an expense payment service element.

13. A system for supporting a service based on an information terminal, comprising:
an application server accessing the information terminal through a router, constructing a virtual reality space and an augmented reality space associated with a service element corresponding to a predetermined service provided by a predetermined institution, and transmitting the constructed virtual reality space and augmented reality space to the information terminal through the router;
a service element server being associated with the application server and providing the service element to the application server in accordance with a request from the application server; and
a virtual reality/augmented reality server being associated with the application server and providing the virtual reality space and the augmented reality space to the application server in accordance with the request from the application server.

14. The system of claim 13, wherein the application server includes:
an application service database storing an application service;
a command receiving unit receiving a command associated with a request for a virtual experience service corresponding to the predetermined service provided by the predetermined institution from the information terminal through the router;
an application service selecting unit selecting the application service by inquiring into the application service database in accordance with the received command; and
an application service executing unit constructing the virtual reality space and the augmented reality space corresponding to the predetermined institution by executing the selected application service and associating the service elements associated with the predetermined service with the constructed virtual reality space and augmented reality space.

15. The system of claim 14, wherein the application service executing unit constructs the virtual reality space by receiving the virtual reality information corresponding to the predetermined institution from the virtual reality/augmented reality server, receives the service element corresponding to the predetermined service from the service element server and associates the service element with the virtual reality space, and transmits the service element associated with the virtual reality space to the information terminal in real time.

16. The system of claim 15, wherein:
the predetermined institution is a medical institution, and
the application service executing unit associates the service element corresponding to the medical service provided by the medical institution with the virtual reality space corresponding to the medical institution and transmits the service element associated with the virtual reality space to the information terminal in real time.

17. The system of claim 16, wherein the application service executing unit associates the service element corresponding to the medical service provided by the medical institution with the augmented reality space corresponding to the medical institution and transmits the service element associated with the augmented reality space to the information terminal positioned in the medical institution in real time through the router and a wireless access point device installed in the medical institution.

18. The system of claim 17, wherein the application service executing unit receives present positional information of the information terminal positioned in the medical institution through the command receiving unit, constructs the augmented reality space corresponding to the received present positional information, and associates the service element corresponding to the present positional information with the constructed augmented reality space to transmit the service element to the information terminal.

19. The system of claim 17, wherein the application service executing unit constructs the augmented reality space by receiving the virtual reality information corresponding to the received present positional information from the virtual reality/augmented reality server, and receives the service element corresponding to the present positional information from the service element server and associates the service element with the constructed augmented reality space.

20. The system of claim 13, wherein the application server, the virtual reality/augmented reality server, and the service element server are logically divided and implemented in one server.
